(19) United States
(12) Patent Application Publication
(10) Pub. No.: US 2007/0256253 A1
(43) Pub. Date: Nov. 8, 2007

(54) METHOD FOR DELIVERING LIQUID FABRIC TREATING COMPOSITIONS TO CLOTHING IN A CLOTHES DRYER

(76) Inventors: J. Michael Ogden, Cincinnati, OH (US); Arthur V. Shannon III, Hopewell, NJ (US)

Correspondence Address: GRAY ROBINSON, P.A., P.O. Box 2328, FT. LAUDERDALE, FL, 33303-9998, US

(21) Appl. No.: 11/749,917

(22) Filed: May 17, 2007

Related U.S. Application Data
(63) Continuation-in-part of application No. 11/422,889, filed on Jun. 8, 2006.
Application No. 11/422,889 is a continuation-in-part of application No. 10/826,975, filed on Apr. 16, 2004, now abandoned.
Application No. 10/826,975 is a continuation-in-part of application No. 10/119,343, filed on Apr. 8, 2002, now abandoned.

(51) Int. Cl. C11D 11/00

(52) U.S. Cl. 8/137

(57) ABSTRACT

A method of delivering liquid fabric treating compositions to clothing in a clothes dryer is provided which employs a dryer sheet, preferably a substrate such as a sheet of non-woven material, having a liquid fabric treating composition retained in liquid form on or in the substrate. The dryer sheet is introduced into a rotary clothes dryer with laundered, damp clothing and a transfer cycle is initiated wherein little or no heat is applied to the clothing or to the dryer sheet thus allowing an effective amount of the liquid fabric treating composition to be transferred from the dryer sheet into the fabric of the articles of clothing as a result of contact of the composition with the water contained within the clothing. At the conclusion of the transfer cycle, a drying cycle may be initiated to introduce sufficient heat into the dryer so that water may be removed from the clothing.

### RELATED APPLICATIONS

This is a continuation-in-part of U.S. patent application Ser. No. 11/422,889, filed Jun. 8, 2006 and entitled “Dryer Sheet,” which is a continuation-in-part of U.S. patent application Ser. No. 10/826,975, filed Apr. 16, 2004, now abandoned, which is a continuation-in-part of U.S. patent application Ser. No. 10/119,343, filed Apr. 8, 2002, now abandoned.

### FIELD OF THE INVENTION

This invention relates to a method for delivering a liquid fabric treating composition to clothing within a clothes dryer.

### BACKGROUND OF THE INVENTION

Fabric treating compositions have been developed which are capable of imparting one or more of a variety of properties to articles of clothing, such as softness, fragrance, brightening, bodying, reduced static, anti-soiling, anti-creasing and others. Two of the most prominent commercially available methods of treating clothing include liquid fabric softeners employed in washing machines, and “dry” dryer sheets used in rotary clothes dryers.

“Dry” dryer sheets, such as those commercially available from The Proctor & Gamble Company of Cincinnati, Ohio under the trademark Bounce®, generally comprise sheets of non-woven material impregnated with a composition usually consisting of a cationic softening agent, antistatic agents, dispersing agents and a fragrance. The softening or other fabric treating agent is applied to the non-woven material and then dried in an oven so that it is completely “dry” when ready for use. One or more dry dryer sheets are placed into a rotary clothes dryer with freshly laundered, damp items of clothing, where they remain for the entire drying cycle. The composition on the sheet of non-woven material is released in the course of the drying cycle as a result of the heat within the clothes dryer, and contact with the clothing induced by the tumbling action of the dryer.

Although arguably more convenient to use than liquid fabric softeners intended for the washer, the dry dryer sheets described above also have a number of limitations. First, dry dryer sheets exhibit relatively poor softening capability compared to liquid fabric softeners. One reason for this is that dry dryer sheets depend to a large extent on physical contact with the clothing within the dryer during the drying cycle in order to effectively transfer the softening composition to the clothes. If the dryer sheet becomes trapped within the sleeve of a shirt, a pant leg or the like, it cannot make contact with other articles of clothing within the dryer. Even if the dry dryer sheet freely contacts the clothing during a drying cycle, the softening agent it carries does not penetrate the fabric to the same extent as liquid fabric softener in the rinse cycle of the washing machine.

Another limitation of dry dryer sheets is that a relatively high temperature is required in order to activate the softening or other fabric treating agent on the non-woven sheet and release it into the fabric of the clothing. Most commercially available clothes dryers have several heat settings to accommodate different types of clothing. For example, delicate fabrics are preferably dried at lower heat settings, or at ambient temperature, compared to clothing made from cotton or the like which require high heat settings to dry. At lower heat settings, dry dryer sheets are generally ineffective and therefore delicate fabrics or other clothing dried at lower temperatures may not exhibit the desired softness and feel when worn. This is a pervasive problem in many European countries, as well as other countries around the world, where the high cost of energy makes it a necessity to operate clothes dryers at lower temperatures. On the other hand, it has been observed that clothing dried at high heat settings and temperatures often exhibit an increased amount of static cling and wrinkling. This is true even when the dry dryer sheet is provided with anti-static agents. Furthermore, in addition to creating static cling and wrinkling, high drying temperatures are hard on fabrics, tending to break them down over time.

### SUMMARY OF THE INVENTION

A method of delivering fabric treating compositions to clothing in a clothes dryer is provided which employs a “wet” dryer sheet, preferably a substrate such as a sheet of non-woven material, having a fabric treating composition retained in liquid form on or in the substrate. The dryer sheet is placed into a rotary clothes dryer with laundered, damp clothing and a transfer cycle is initiated wherein little or no heat is applied to the clothing or to the dryer sheet thus allowing an effective amount of the liquid fabric treating composition to be transferred from the dryer sheet into the fabric of the articles of clothing as a result of contact of the composition with the water contained within the damp clothing. At the conclusion of the transfer cycle, a drying cycle is initiated to introduce sufficient heat into the dryer so that water from the clothing may be removed.

The components of the liquid fabric treating composition are preferably combined at ambient temperature, without the addition of heat, and may be applied onto the substrate without the addition of heat. In the presently preferred embodiment, non-woven material forms the substrate of the dryer sheet because of its ability to retain the liquid fabric treating composition in liquid form thereon, and to permit the transfer of such composition to the damp clothing within the clothes dryer during a drying cycle.

### DETAILED DESCRIPTION OF THE INVENTION

The dryer sheet employed in the method of this invention comprises the combination of a fabric treating composition having at least one active ingredient and a substrate capable of retaining the composition in liquid form thereon and permitting the transfer of the composition to damp articles of clothing within a clothes dryer, as described below. For purposes of the present discussion, the term “active ingredient” refers to a wide variety of components which, when applied to an article of clothing, are capable of imparting a particular property or characteristic to the clothing. The term “active ingredient” also is intended to encompass components which may be applied to a substrate within the clothes dryer, and then may be imparted to the skin of a wearer of the clothing. The term “article of clothing” is intended to be broadly construed as applying to essentially any item which is commonly dried in a clothes dryer, including, without limitation, clothing, sheets, towels, rugs and other items made of fabric. Additionally, the term “clothes dryer” or “rotary clothes dryer” refers to a rotary hot air dryer which includes a rotating drum within which articles to be dried are subjected to a flow of heated air, typically at a temperature of about 40° C. to 90° C. Each component of the dryer sheet of this invention is described separately below, followed by a discussion of the method of this invention which may employ the dryer sheet.

Liquid Fabric Treating Composition

A liquid fabric treating composition which may be employed in the method of this invention generally comprises a carrier and one or more active ingredients each capable of imparting a particular property or characteristic to an article of clothing within a clothes dryer. Such active ingredients may include, without limitation, anti-creasing agents, anti-soil agents, anti-static agents, bacteriostatic agents, brightening agents, bodying agents, softening agents, dyes, fiber emollients, finishing agents, fragrances, insect repellants, germicides, lubricants, mildew-proofing agents, moth-proofing agents, shrinkage controllers and sizing agents.

In the presently preferred embodiment, the carrier is water. The active ingredients noted above may include different classes of compounds, as is well known to those of ordinary skill in the art, but each compound selected for the liquid fabric treating composition of this invention may be added to the carrier to form a solution, dispersion or emulsion at ambient temperatures, without the addition of heat.

One particular type of active ingredient suitable for use in the liquid fabric treating composition may comprise a single material or a mixture of materials which are known to provide benefits to the skin. As discussed below, the fabric treating composition is applied and retained in liquid form on a substrate and transferred from the substrate to articles of clothing within a clothes dryer during operation of the dryer. Clothing which receives a skin-treating active ingredient from the dryer sheet subsequently transfers it to the skin when the clothing is worn by an individual.

The skin-treating active ingredient can comprise essentially any known component for treating human skin, such as insect repellants, UV absorbers, skin moisturizers, tanning agents, wrinkle removers, deodorants, cellulite reducers, vitamins, anti-oxidants, minerals, lipid layer enhancers, hair growth suppressants, emollients, botanical actives and the like. The skin treating active ingredient can be derived from a broad range of classes of materials such as emollients, lubricants, super-fatting agents, natural extracts which provide benefits to the skin depending upon the nature of the natural extracts, the lees from wine-making, DNA derivatives, hydrolyzed proteins both of animal and vegetable origin, derivatives of the hydrolyzed proteins, plant extracts, the skin-active portions of plant extracts and the like.

One particular skin-treating active ingredient suitable for use in the liquid fabric treating composition is commercially available under the trademark PLANTATEX™ HCC owned by Cognis Deutchland GmbH & Co. This ingredient is a wax dispersion with glyceryl esters, an emulsifier and water. It contains skin treating components such as glycerol oleate, which is a lipid layer enhancer.

Although not required, an emulsifier may be added to the liquid fabric treating composition when using PLANTATEX HCC and similar skin-treating active ingredients to promote transfer of the composition to the substrate, described below. It is believed that the additional emulsifier adds softness to the articles of clothing without decreasing the water-absorbency, which typically occurs with “dry” dryer sheets of the type described above in connection with a discussion of the prior art. Suitable emulsifiers and co-emulsifiers are nonionic, anionic, cationic or amphoteric emulsifiers, zwitterionic surfactants and esterquats, all of which are well known in the art.

The liquid fabric treating composition may further include one or more additives and auxiliaries to provide known benefits to the treated articles of clothing such as anti-static properties, a pleasing aroma, improved shelf life and the like. For example, preservatives such as formaldehyde, parabens, pentanediol, sorbic acid and other classes of compounds may be added, as is well known in the art. A number of different fragrances can be employed in the composition to create the desired smell of the clothing, including, without limitation, rose oil, lavender, lilac, jasmine, vanilla, wisteria, lemon, apple blossom or compound bouquets such as citrus, spice, aldehydic, woods, oriental, baby powder and others.

When employing a skin-treating active ingredient in the liquid fabric treating composition, such as PLANTATEX HCC, the composition comprises from 5% by weight to 95% by weight of the skin-treating active ingredient; from 0.1% by weight to 40% by weight of at least one emulsifier; from 0% by weight to 35% by weight of auxiliaries and additives; from 0% by weight to 95% by weight of a carrier; preferably, from 10% by weight to 75% by weight of the skin-treating active ingredient; from 0.5% by weight to 30% by weight of at least one emulsifier; from 20% by weight of auxiliaries and additives; and most preferably, from about 15% by weight to about 50% by weight of the skin-treating active ingredient; from about 5% by weight to about 20% by weight of at least one emulsifier; from about 35% by weight to about 75% by weight of a carrier; and from about 10% by weight to about 20% by weight of auxiliaries and additives.

As noted above, the carrier is usually water but can be other liquid components which provide a vehicle for impregnating the substrate with the skin-treating active ingredient and the emulsifier. The carrier can be one of the components of the skin-treating active ingredient or the emulsifier or mixture of emulsifiers which can provide a mixture which is liquid at ambient temperature and has a viscosity allowing application of the composition onto the substrate.

Substrate

The liquid fabric treating composition is applied by spraying, dipping or other suitable method to a substrate having at least two characteristics needed to allow the dryer sheet used with the method of this invention to successfully transfer an effective amount of the active ingredient(s) of the composition to articles of clothing within a clothes dryer in the course of operation of the dryer. One requirement of the substrate is that it receive and maintain the fabric treating composition in liquid form, i.e. from the time the composition is applied to the substrate until it is placed in the clothes dryer with laundered, damp clothing. Secondly, the substrate must permit the transfer of liquid fabric treating composition to the damp clothing during operation of the clothes dryer. As described below, different types of fibers used to form non-woven sheets may be absorbent or adsorbent. When the liquid fabric treating composition is applied to such fibers in a non-woven sheet it may be absorbed into the fibers or retained in spaces between adjacent fibers. For purposes of the present discussion, the substrate is considered to be “impregnated” with the liquid fabric treating composition, and that term should be broadly construed to apply where the liquid is absorbed or adsorbed “in,” “on” or “between” fiber forming the non-woven sheet.

In the presently preferred embodiment, the substrate is formed of a sheet of non-woven material, although it is contemplated that other materials capable of performing the two functions noted above could be utilized, including woven material, foam material, especially open cell foam material, sponge and similar materials. Non-woven material is particularly suited to the present application due to its relatively low cost, ease of processing, biodegradation capability and ability to absorb moisture. It is typically formed of natural fibers such as cellulosic, plant-based, polylatic acid material etc., or synthetic fibers such as polyester, nylon, polypropylene, polytrimethylene terephthalate and polyethylene terephthalate, or, blends of such natural and synthetic fibers. The fibers are formed in a sheet, typically by hydro-entanglement or needle-entanglement.

It has been found that only certain configurations and types of non-woven material are suitable for use in the method of the present invention. Most natural fibers have been found to readily absorb the fabric treating composition, and maintain it in liquid form thereon, but certain non-woven sheets made from such fibers fail to transfer the liquid composition to the damp clothing in the dryer. In the case of certain natural fibers, the liquid fabric treating composition is absorbed and retained in the fibers with little or no migration or transfer of the composition being permitted upon contact with the damp clothing in the dryer. Synthetic fibers, on the other hand, are generally adsorbent in nature. The liquid fabric treating composition may be captured between adjacent fibers within a hydro-entangled or needle-entangled non-woven sheet without being absorbed into the fibers. As a result, the composition may be readily transferred to the damp articles of clothing in the dryer as a result of contact with the water in such articles. However, it has been found that non-woven sheets made from solely or predominantly synthetic fibers which are impregnated with the liquid fabric treating composition have an unacceptable “slimy” or slick feel when handled, and the composition readily transfers to the hands when placing the dryer sheet into the clothes dryer.

It has been found that a non-woven sheet made of a blend of natural fibers and synthetic fibers, and having apertures throughout the length and width of the sheet, satisfies the dual requirements noted above. The term “aperture” refers to holes in the non-woven sheet which are visible to the naked eye. In a presently preferred embodiment of this invention, the apertures are arranged in substantially uniform columns and rows throughout the length and width of the non-woven sheet. The number of apertures, and, hence, their relative size, ranges from about 6 holes by 6 holes to about 12 holes by 12 holes, per square inch. In other words, at one extreme there are about 6 holes extending in one direction (Y axis) and 6 holes extending in a perpendicular direction (X axis) for a total of about 36 holes per square inch. At the other extreme, the non-woven sheet has 12 holes extending in one direction (Y axis) and 12 holes extending in a perpendicular direction (X axis) for a total of about 144 holes per square inch. The fibers of the non-woven material extending between the holes in the sheet are impregnated with the liquid fabric treating composition and retain it in liquid form thereon. The presence of the holes in the sheet substantially increases the surface area of the fibers which is exposed and may come into contact with the damp clothing in the dryer. Not only are the opposite sides of the sheet exposed, but the area of the fibers extending along the holes in the sheet is exposed, e.g. the area along the thickness of the non-woven sheet. As a result, the liquid fabric treating composition is much more readily released from an apertured non-woven sheet and transferred to articles of clothing within the dryer due to contact with the water contained in the clothing.

One presently preferred non-woven material is fabricated from fibers sold under the “Tencel” trademark which are commercially available from Courtaulds Fibers, Inc. of Axis, Ala. Tencel fibers are manufactured from a solvent spinning process in which wood pulp and amine oxide solution are mixed and heated until the cellulose dissolves. The resulting solution is then extruded into a dilute aqueous solution of the amine oxide, which precipitates the cellulose as fibers. The Tencel fibers exhibit a dry tensile strength in excess of other man-made cellulosic fibers and many synthetics, and have a tensile strength when wet of about 85% of its dry tensile strength. Such fibers absorb liquid up to about 800% of their dry weight, and therefore provide a highly liquid absorbent substrate when hydroentangled to form a non-woven sheet.

The non-woven sheet employed in the method of this invention may be formed of Tencel or other natural fibers such as rayon, cellulosic and polylatic acid material, or a blend of such fibers and synthetic fibers such as polyester, nylon, polypropylene, polytrimethylene terephthalate, polyethylene terephthalate. The content of fibers in the non-woven sheet may range from about 70% natural fibers and 30% synthetic fibers, to about 30% natural fibers and 70% synthetic fibers. One presently preferred blend of fibers forming the non-woven sheet of this invention is 70% Tencel fibers and 30% polyester, which is commercially available as a fine apertured, spun laced non-woven sheet (12 holes by 12 holes configuration) from Ahlstrom Green Bay, Inc. under model number SX-156.

It is noted that the substrate employed in the dryer sheet described herein has been characterized throughout as being capable of retaining the fabric treating composition in “liquid form” thereon. The term “liquid form” in the context of the present invention refers to the generally understood state of a fluid in which the fluid has a definite volume without a definite shape except that temporarily given by a container or the like. “Liquid form” does not mean a gel or gelled. The fabric treating composition of the present invention is applied and retained in “liquid form” within the substrate in the sense that it has a definite volume, assumes the shape of the substrate and can be transferred to the damp articles of clothing within a clothes dryer during the course of operation of the dryer as a result of contact with the water contained in such articles of clothing.

The dryer sheet employed in the method of this invention will be better understood from the examples which follow, all of which are intended for illustrative purposes only and are not meant to unduly limit the scope of the invention in any way.

### EXAMPLE I

A skin-treating composition was prepared containing:

| | % wt |
|---|---|
| Water | 49.4 |
| PLANTATEX HCC | 50.0 |
| KATHON CG-ICP | 0.05 |
| Fragrance* | 0.5 |

*Givaudin UM 046904/00 floral fruity fragrance

Charge a mixing vessel with water. Add PLANTATEX® HCC with moderate agitation. After the mixture is uniform, add KATHON CG-ICP and fragrance. KATHON CG-ICP is a preservative commercially available from Cognis Deutchland GmbH & Co. Continue mild agitation to prevent finished batch from separating. Separation will occur within a few hours after agitation is stopped. The mixture was applied to a non-woven substrate (SX285 from Greenbay Nonwovens) at a weight ratio of about 1:6.5 (substrate: fabric treating composition). Both the mixing of components and application of the mixture onto a non-woven substrate are performed at room temperature.

### EXAMPLE II

A skin-treating composition was prepared containing:

| | % wt |
|---|---|
| Water | 45.45 |
| PLANTATEX HCC | 50.0 |
| DEHYQUART ACA | 4.0 |
| KATHON CG-ICP | 0.05 |
| Fragrance* | 0.5 |

*Givaudin UM 046904/00 floral fruity fragrance

Charge a mixing vessel with water. Add PLANTATEX HCC and then DEHYQUART ACA with moderate agitation. DEHYQUART A-C4 is commercially available from Cognis Deutchland GmbH & Co. The mixture was applied to a non-woven substrate (SX285 from Greenbay Nonwovens) at a weight of about 1:6.5 (substrate fabric treating composition). Both the mixing of components and application of the mixture onto a non-woven substrate are performed at room temperature.

### EXAMPLE III

A skin-treating composition was prepared containing:

| | % wt |
|---|---|
| PLANTATEX HCC | 93.95 |
| DEHYQUART ACA | 4 |
| KATHON CG-ICP | 0.05 |
| Fragrance* | 2.0 |

*Givaudin UM 046904/00 floral fruity fragrance

Charge a mixing vessel with PLANTATEX HCC, and then add DEHYQUART ACA, KATHON CG-ICP and the fragrance with moderate agitation. The mixture was applied to a non-woven substrate (SX-156 from Ahlstrom Green Bay, Inc. of Green Bay, Wis.) at a loading of 4 grams per sheet. The sheet size was 7 inches by 8 inches. Both the mixing of components and application of the mixture onto a non-woven substrate are performed at room temperature.

While Example III indicates that the non-woven sheet was given a loading of 4 grams of the liquid fabric treating composition, it is contemplated that loadings in the range of 2 grams to 4 grams would provide a suitable quantity of composition for transfer to clothing within a dryer. Such loading is independent of the size of the non-woven sheet, i.e., the sheet may be 5 inches by 5 inches, 8 inches by 8 inches or some other dimensions, and each would receive the same amount of liquid fabric treating composition, by weight. Additionally, while the percentage of fragrance indicated in Example III is 2% by weight, it is contemplated that the fragrance could be added to the mixture in quantities in the range of about 0.5% to 4% by weight, while changing the percentage of PLANTATEX HCC accordingly. Further, the amount of DEHYQUART ACA, or similar agent, may be varied in the range of about 4% to 10% by weight, while changing the percentage of PLANTATEX HCC accordingly.

Method

As noted above, the present invention is directed to a method of transferring a liquid fabric treating composition to clothing within a clothes dryer. The dryer sheet containing a liquid fabric treating composition such as described above may be used in the method of this invention. Without wishing to be limited by any particular theory of how the liquid fabric composition is transferred from the dryer sheet to clothing within a clothes dryer, it is believed that such transfer occurs as follows. The fabric treating composition is maintained in liquid form on the substrate, e.g. a sheet of non-woven material typically having a width and length each in the range of about 6-8 inches. It is believed that the active ingredient(s) within the liquid fabric treating composition is transferred to the clothes within the dryer as a result of contact of the composition with the water held within the damp clothing in the dryer. No precise volumetric measurement can be given for the amount of water contained within freshly laundered articles of clothing due to variations in the efficiency of the spin cycle of different washing machines and the degree of water retention of articles of clothing made from different materials (cotton, synthetics etc), but freshly laundered articles of clothing nevertheless contain some amount of water when placed in a clothes dryer, and for purposes of the present discussion are characterized as “damp.” The liquid fabric treating composition migrates or transfers to the damp clothing, moving throughout the water held in the clothing, and transfers from one article of clothing to another as the dryer sheet and clothing contact one another while being tumbled together within the rotary clothes dryer. It is believed that the dryer sheet need not make contact with the water contained in each individual article of clothing, but that it need only contact at least some of the articles to transfer the composition thereon. Once some articles of clothing receive the fabric treating composition, they transfer it to other articles by contact with the water in such other articles.

Conventional clothes dryers have a number of heat settings, ranging from low temperature settings for delicate articles of clothing to high heat settings for “whites,” e.g. towels, underwear etc. While the dryer sheet employed herein retains the fabric treating composition thereon in liquid form, it is relatively small in dimension and has a small amount of liquid compared to the water held in the articles of clothing to be dried. Consequently, when drying a load of “white” articles of clothing at a high heat setting, for example, the dryer sheet is susceptible to “drying out” or having the liquid fabric treating composition evaporate from the substrate by exposure to the heated air in the dryer, before the composition may be effectively transferred to the clothing. The extent of removal of the liquid fabric treating composition from the substrate of the dryer sheet is dependent on the level of heat introduced into the dryer, and different heat settings will result in different rates of removal of the composition from the substrate. Nevertheless, and regardless of the heat setting and type of clothing in the dryer, it is desirable to enhance the transfer process.

The method of this invention is intended to enhance and maximize the efficiency of the transfer process described above by adding a “transfer cycle” to the operation of a conventional clothes dryer. After the dryer sheet of this invention is placed into the clothes dryer with damp clothing, a transfer cycle is initiated where in the preferred embodiment, the clothing and dryer sheet are tumbled with one another without the addition of heat into the rotating drum of the dryer. The liquid fabric treating composition carried by the dryer sheet herein is most effectively transferred to the clothing within the dryer when the clothing in the dryer has its greatest water content and while the largest amount of composition is retained on or in the sheet. The premature addition of heat into the clothes dryer tends to remove moisture from the clothing, and to dry out the dryer sheet, both of which adversely affect the transfer of an effective amount of liquid fabric treating composition from the dryer sheet to the clothing. As such, the transfer cycle in the preferred embodiment of this invention in which no heat is added while the clothes and dryer sheet tumble together enhances and maximizes the “transfer efficiency” of the composition to the clothing, i.e. the effectiveness with which the liquid fabric treating composition is removed from the dryer sheet and then is absorbed and/or adsorbed into the fabric of the clothing, consistent with the theory of operation described above. Transfer efficiency is important in a number of respects. The greater the transfer efficiency, the more the clothing exhibits the property or properties of the particular active ingredient(s) present in the composition, e.g. softening, anti-creasing, anti-soil, anti-static etc., because there is more active ingredient(s) present on the clothing. Additionally, greater transfer efficiency requires a lesser amount of liquid fabric treating composition to be applied to the substrate of the dryer sheet to achieve the same performance benefits compared to a dryer sheet with more composition but which is used in a clothes dryer without the transfer cycle according to the method of this invention. Once the transfer cycle is completed, a “drying cycle” may then be initiated in which heat is introduced into the drum of the rotary dryer at the desired temperature setting selected by the user.

It should be understood that the dryer sheet discussed herein is not incapable of transferring liquid fabric treating composition to clothing within a clothes dryer in the absence of a “transfer cycle” as contemplated in this invention. And, as noted above, the extent of drying experienced by the clothing and the dryer sheet is a function of the heat setting employed by the user. Accordingly, it is contemplated that the “transfer cycle” of this invention may involve the application of at least some amount of heat into the dryer, but such heat level should be low enough to avoid adversely affecting the transfer efficiency of the liquid fabric treating composition from the sheet to the clothing.

While the invention has been described with reference to a preferred embodiment, it should be understood by those skilled in the art that various changes may be made and equivalents substituted for elements thereof without departing from the scope of the invention. Therefore it is intended that the invention not be limited to the particular embodiment disclosed as the best mode contemplated for carrying out the invention, but that the invention will include all embodiments falling within the scope of the appended claims.

What is claimed is:

1. A method of transferring a liquid fabric treating composition to clothing within a clothes dryer, comprising:
(a) providing a substrate impregnated with a liquid fabric treating composition;
(b) introducing the substrate into a clothes dryer with clothing containing water;
(c) tumbling the substrate with the clothing in a transfer cycle wherein no heat is applied to the clothing or to the substrate, an effective amount of the liquid fabric treating composition present on the substrate being transferred to the clothing as a result of contact of the liquid fabric treating composition with the water contained in the clothing; and
(d) applying heat to the clothing in a drying cycle to remove the water from the clothing.

2. A method of transferring a liquid fabric treating composition to clothing within a clothes dryer, comprising:
(a) providing a substrate impregnated with a liquid fabric treating composition;
(b) introducing the substrate into a clothes dryer with clothing containing water;
(c) tumbling the substrate with the clothing in a transfer cycle wherein an effective amount of the liquid fabric treating composition present on the substrate is transferred to the clothing as a result of contact of the liquid fabric treating composition with the water contained in the clothing, the amount of heat applied to the clothing and to the substrate during the transfer cycle being less than that required to dry the substrate prior to transfer of an effective amount of the fabric treating composition to the clothing;
(d) initiating a drying cycle wherein sufficient heat is applied to the clothing to remove the moisture from the clothing.

3. The method of claim 2 in which step (c) comprises applying no heat to the clothing or to the substrate during the course of the transfer cycle.
